(19) United States
(12) Patent Application Publication
(10) Pub. No.: US 2026/0292083 A1
(43) Pub. Date: Sep. 24, 2026

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Kiyoshi YASUKAWA, Kanagawa (JP)

(73) Assignee: FUJIFILM Business Innovation Corp., Tokyo (JP)

(21) Appl. No.: 19/311,912

(22) Filed: Aug. 27, 2025

(30) Foreign Application Priority Data
Mar. 18, 2025 (JP) 2025-043634

(51) Int. Cl. H04N 1/00; H04N 1/32

(52) U.S. Cl. CPC H04N 1/00514; H04N 1/00424; H04N 1/0097; H04N 1/32101

(57) ABSTRACT

An information processing system includes a memory, and a processor configured to store, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.

### CROSS-REFERENCE TO RELATED APPLICATIONS

This application is based on and claims priority under 35 USC 119 from Japanese Patent Application No. 2025-043634 filed Mar. 18, 2025.

### BACKGROUND

### (i) Technical Field

The present disclosure relates to an information processing system, a non-transitory computer readable medium, and a method.

### (ii) Related Art

Japanese Unexamined Patent Application Publication No. 2007-55099 discloses an image forming apparatus that reads customization information including data regarding a customization screen of a user registered in advance and that displays the customization information on a display.

### SUMMARY

When a plurality of users shares an information processing apparatus such as an image forming apparatus and personal setting information regarding each user is individually and independently stored in a memory such as a nonvolatile memory, the amount of memory required to store personal setting information regarding all the users increases as the number of users increases.

Aspects of non-limiting embodiments of the present disclosure relate to an information processing system, a non-transitory computer readable medium, and a method capable of reducing the amount of memory required to store personal setting information, compared with a case where personal setting information regarding an operation screen changed by each user is individually and independently stored in a memory.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a memory, and a processor configured to store, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.

### BRIEF DESCRIPTION OF THE DRAWINGS

An exemplary embodiment of the present disclosure will be described in detail based on the following figures, wherein:

FIG. 1 is a diagram illustrating a system configuration of an information processing system according to an exemplary embodiment of the present disclosure;

FIG. 2 is a block diagram illustrating hardware configuration of an image forming apparatus according to the exemplary embodiment of the present disclosure;

FIG. 3A is a diagram illustrating an example of an authentication information management table, and FIG. 3B is a diagram illustrating an example of a customization information management table;

FIG. 4 is a diagram illustrating an example of an operation screen of initial settings on an operation panel of the image forming apparatus;

FIG. 5 is a diagram illustrating an example of a login screen on the operation panel of the image forming apparatus;

FIG. 6A is a diagram illustrating an example of a personal setting screen of user A, FIG. 6B is a diagram illustrating an example of a personal setting screen of user C, and FIG. 6C is a diagram illustrating an example of a personal setting screen of user E;

FIG. 7 is a flowchart illustrating an example of operation of the image forming apparatus

FIG. 8A is another diagram illustrating the example of the personal setting screen of user E, FIG. 8B is a diagram illustrating an example of an operation screen displayed during customization, and FIG. 8C is a diagram illustrating an example of the personal setting screen of user E after the customization;

FIG. 9A is a diagram illustrating an example of update of an authentication information management table after the customization, and FIG. 9B is a diagram illustrating an example of update of a customization information management table after the customization;

FIG. 10 is a flowchart illustrating another example of the operation of the image forming apparatus;

FIG. 11A is a diagram illustrating an example of an operation screen displayed during the customization, FIG. 11B is a diagram illustrating another example of the operation screen displayed during the customization, FIG. 11C is a diagram illustrating an example of an operation screen after a selection operation is performed in FIG. 11B, and FIG. 11D is a diagram illustrating another example of the operation screen after a selection screen is performed in FIG. 11C;

FIG. 12 is a flowchart illustrating another example of the operation of the image forming apparatus; and

FIG. 13A is a diagram illustrating an example of an operation screen displayed during login, FIG. 13B is a diagram illustrating an example of an operation screen after a selection operation is performed in FIG. 13A, and FIG. 13C is a diagram illustrating an example of an operation screen after a selection operation is performed in FIG. 13B.

### DETAILED DESCRIPTION

Next, an exemplary embodiment of the present disclosure will be described in detail with reference to the drawings.

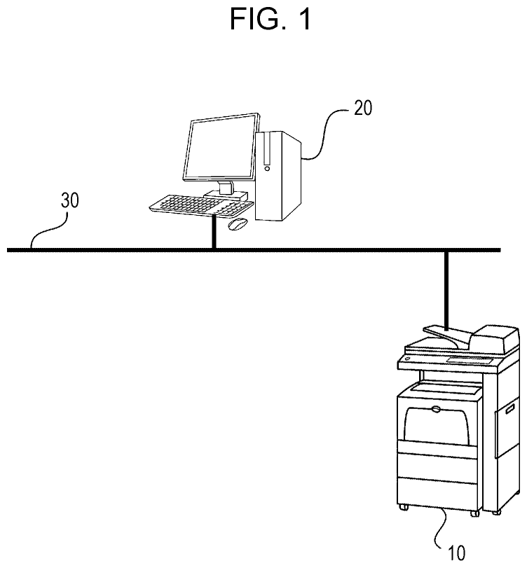

FIG. 1 is a diagram illustrating configuration of an information processing system according to the exemplary embodiment of the present disclosure.

As illustrated in FIG. 1, the information processing system according to the exemplary embodiment of the present disclosure has a configuration in which an image forming apparatus 10 and a terminal apparatus 20 are connected to each other over a network 30.

The terminal apparatus 20 generates print data and transmits the generated print data to the image forming apparatus 10 over the network 30. The terminal apparatus 20 is an information processing apparatus configured by installing a program for controlling the image forming apparatus 10 on a personal computer.

The image forming apparatus 10 receives the print data transmitted from the terminal apparatus 20 and outputs an image based on the print data onto a recording medium such as printing paper. The image forming apparatus 10 is an apparatus generally called a “multifunction printer” having a plurality of functions including a printing function, a scanning function, a copying function, a facsimile function, and a mail transmission function. The image forming apparatus 10 is an information processing apparatus configured by installing a program for controlling operation screens used to execute the plurality of functions.

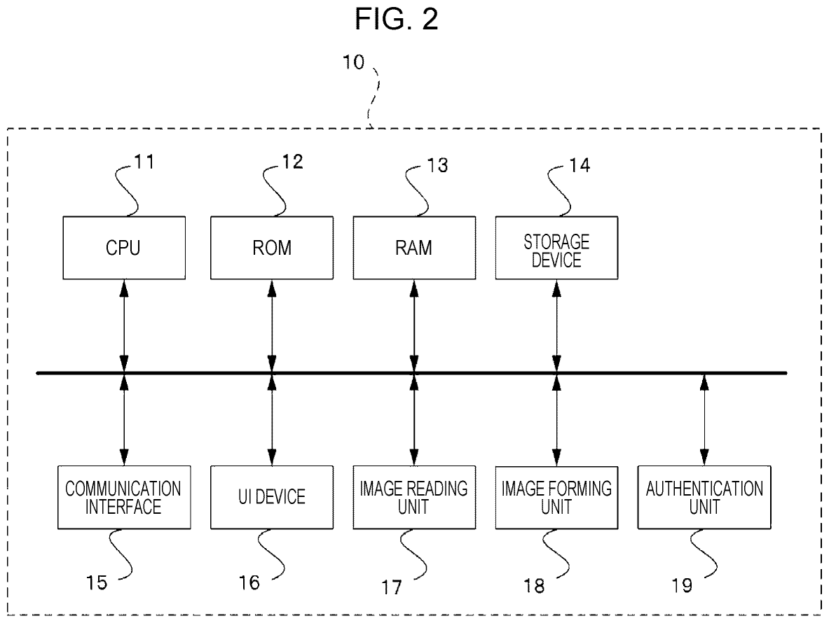

FIG. 2 is a diagram illustrating hardware configuration of the image forming apparatus 10 according to the present exemplary embodiment.

As illustrated in FIG. 2, the image forming apparatus 10 includes a central processing unit (CPU) 11, a read-only memory (ROM) 12, a random-access memory (RAM) 13, a storage device 14, a communication interface 15 that transmits and receives data to and from external apparatuses over the network 30, a user interface (UI) device 16 including a touch panel or a liquid crystal display and a keyboard, an image reading unit 17, an image forming unit 18, and an authentication unit 19. These components are connected to one another via a control bus.

The CPU 11 executes various programs and controls the other components. That is, the CPU 11 reads a program from the ROM 12 or the storage device 14 and executes the program using the RAM 13 as a work area. The CPU 11 controls the other components and performs various types of processing in accordance with the program stored in the ROM 12 or the storage device 14. The CPU 11 is an example of a processor.

The ROM 12 stores various information processing programs and various types of data. The ROM 12 stores information regarding initial settings included in an initial screen (also referred to as a “home screen”) among the operation screens of an operation panel 21 of the image forming apparatus 10. The RAM 13 temporarily stores a program or data as the work area of the CPU 11.

The storage device 14 is implemented as a nonvolatile memory such as a hard disk drive (HDD) or a solid-state drive (SSD), and stores various programs including an operating system and various types of data. The storage device 14 stores authentication information for identifying users and customization information that is personal setting information set for each user, the customization information including information regarding an operation screen initially set by the user or changed (customized) by the user from initial settings and information regarding arrangement of icons that are controls in the operation screen and settings of the icons.

The communication interface 15 is an interface for transmitting and receiving data to and from external apparatuses including the terminal apparatus 20, and employs a standard such as Ethernet (registered trademark), Fiber Distributed Data Interface (FDDI), or Wi-Fi (registered trademark).

The image reading unit 17 optically reads image data from a document or the like. The image forming unit 18 prints image data read by the image reading unit 17 or print data received from the terminal apparatus 20 on the recording medium.

The authentication unit 19 authenticates a user who is attempting to use the image forming apparatus 10 by, for example, asking the user to input a user identifier (ID) and a password or present an IC card.

The CPU 11 is a processor that controls operation of the image forming apparatus 10 by executing predetermined processing on the basis of a control program stored in the ROM 12 or the storage device 14. Although the CPU 11 reads and executes a control program stored in the ROM 12 or the storage device 14 in the present exemplary embodiment, the program may be stored in a storage device such as a compact disc read-only memory (CD-ROM) and provided for the CPU 11, instead.

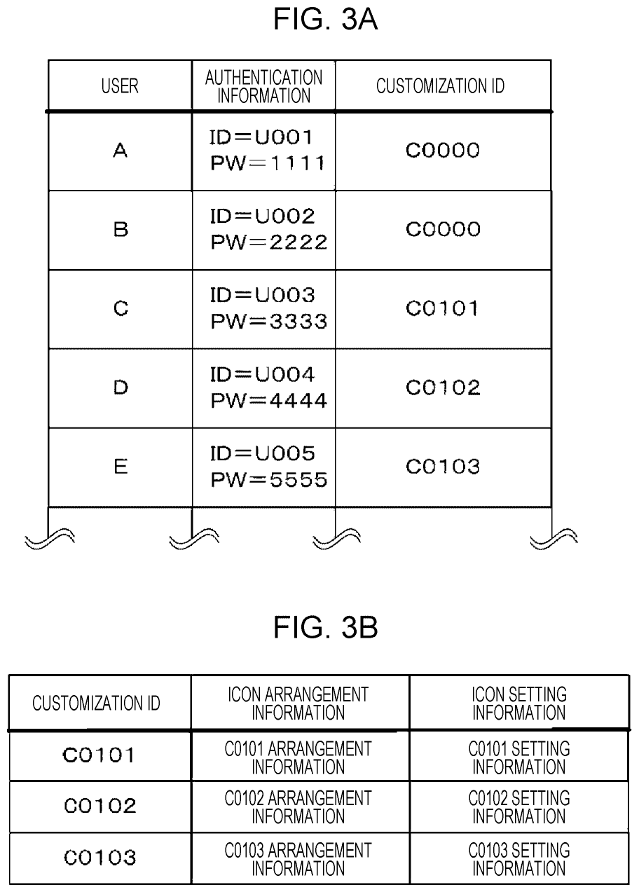

FIG. 3A illustrates an example of an authentication information management table storing authentication information regarding a plurality of users. The storage device 14 stores the authentication information management table.

The authentication information management table stores, for each user, authentication information such as a user ID, which is an identifier of the user, and a password (abbreviated as “PW”) and a customization ID, which is an identifier of information regarding an operation screen and information for referring to customization information of the user or another user, in association with each other. With the authentication information management table, a customization ID for identifying customization information regarding an operation screen of a user can be identified.

FIG. 3B illustrates an example of a customization information management table. The storage device 14 stores the customization information management table.

The customization information management table stores customization IDs and customization information including information regarding arrangement of icons and information regarding settings of the icons in association with each other. That is, customization information is stored for corresponding customization IDs. With the customization information management table, customization information corresponding to each customization ID can be identified.

The information regarding the arrangement of icons includes information regarding removal, addition, or movement of icons on the operation screen. The information regarding the settings of icons includes names of the icons or information regarding operation settings of programs activated by the icons, the information being used to execute functions of the image forming apparatus 10. The functions of the image forming apparatus 10 include print settings such as single-sided printing, double-sided printing, a color mode, and document size, a facsimile function, a mail transmission function, and storage locations for data regarding confidential box numbers and the like.

The icons are figures that are displayed in operation screens and that indicate operation positions for activating specific application programs (apps) and transitioning to specific screens. The figures may include not only designed figures but also various characters such as alphabets, hiragana, katakana, and kanji.

Information regarding initial settings in a case where the customization information is initial settings (e.g., in a case where the customization ID in FIG. 3A is “C0000”) is stored in the ROM 12. In a case where the customization information is customized from the initial settings (e.g., in a case where the customization ID in FIG. 3A is other than “C0000”), the customization information is stored in the storage device 14. That is, when the CPU 11 displays an operation screen on the operation panel 21, which is the UI device 16, the CPU 11 refers to the information regarding the initial settings stored in the ROM 12 and displays the operation screen on the UI device 16 if a customization ID of a logged-in user is “C0000”. If the customization ID of the logged-in user is other than “C0000”, namely “C0101”, “C0102”, “C0103”, or the like, the CPU 11 refers to customization information corresponding to the customization ID of the logged-in user and displays the operation screen on the UI device 16.

That is, the image forming apparatus 10 in the present disclosure separately manages the authentication information set for each user, the information regarding the initial settings of the operation screen, and the customization information in which the operation screen has been customized from the initial settings. The information regarding the initial settings of the operation screen is stored in the ROM 12, and the customization information in which the operation screen has been customized from the initial settings is stored in the storage device 14, which is a nonvolatile memory or the like.

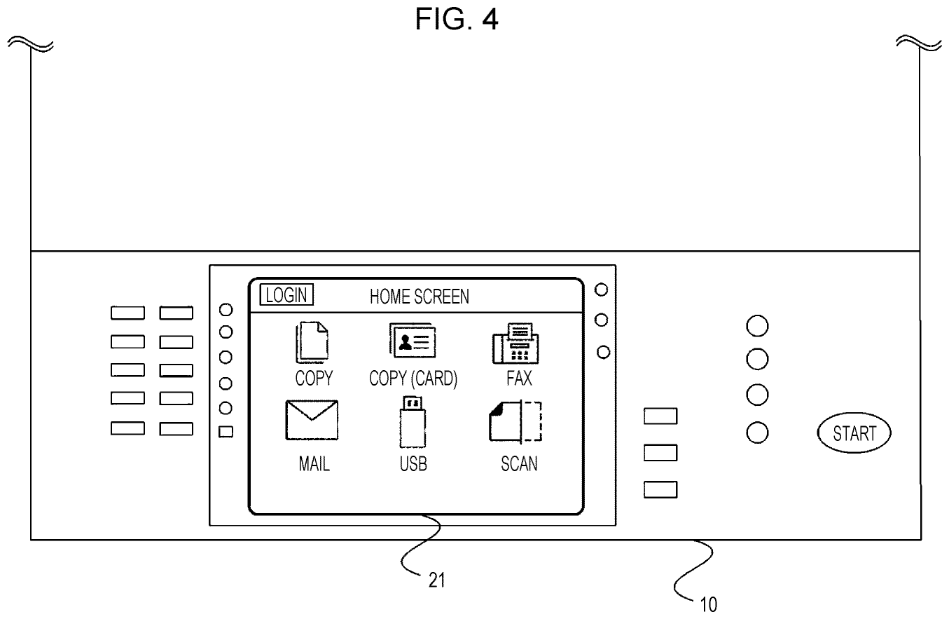

FIG. 4 is a diagram illustrating an example of the operation screen on the operation panel 21 of the image forming apparatus 10 according to the present exemplary embodiment.

The operation screen displays icons for selecting execution of various functions. At this time, the CPU 11 performs control in such a way as to display the operation screen on the basis of the information regarding the initial settings of the operation screen stored in the ROM 12. The operation screen displayed on the basis of the information regarding the initial settings of the operation screen can also be referred to as a home screen or an initial screen. When the user selects one of the icons displayed in the operation screen, the CPU 11 performs control in such a way as to execute a function of the image forming apparatus 10 corresponding to the selected icon.

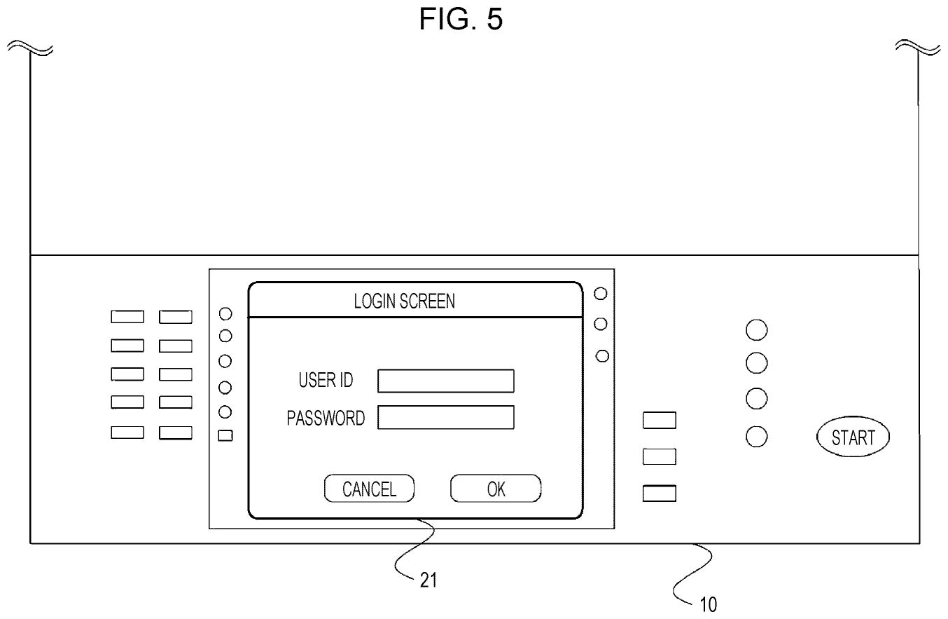

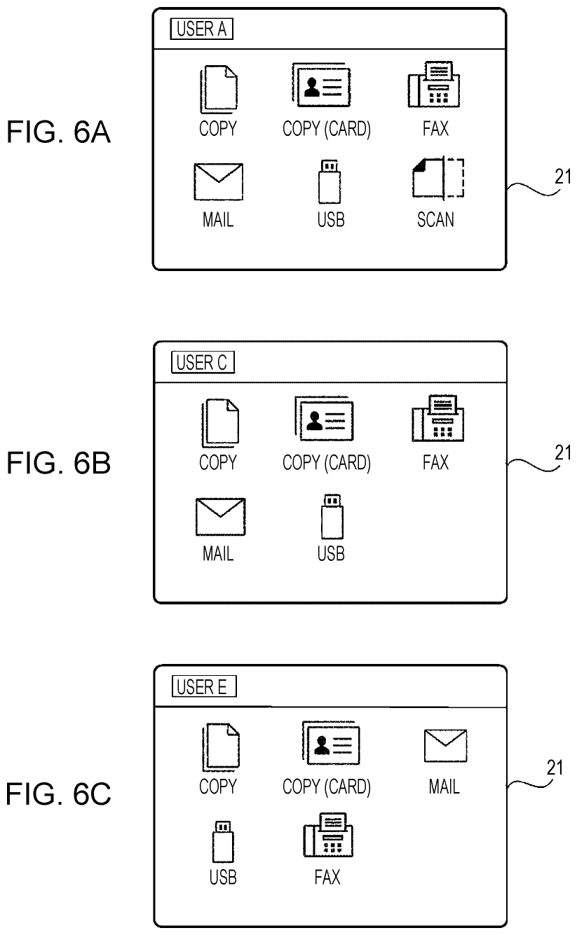

When the user taps a login button on the home screen, a login screen for inputting a user ID and a password is displayed on the operation screen of the operation panel 21 as illustrated in FIG. 5. When the user inputs a user ID and a password on the login screen and taps an OK button, for example, the operation screen of the operation panel 21 displays a personal setting screen of the user, such as one of person setting screens of users illustrated in FIGS. 6A to 6C. The user need not necessarily be authenticated by inputting a user ID and a password, and may be authenticated using an IC card, instead.

Specifically, when the CPU 11 receives a user ID “U001” and a password “1111” as a result of login of user A, the CPU 11 obtains a customization ID “C0000” corresponding to the user ID “U001” and the password “1111” from the authentication information management table stored in the storage device 14. The CPU 11 then reads the information regarding the initial settings on the basis of the customization ID “C0000”, and displays the personal setting screen illustrated in FIG. 6A in the operation screen of the operation panel 21 of the image forming apparatus 10.

When the CPU 11 receives a user ID “U003” and a password “3333” as a result of login of user C, the CPU 11 obtains a customization ID “C0101” corresponding to the user ID “U003” and the password “3333” from the authentication information management table stored in the storage device 14. The CPU 11 then reads customization information for C0101 on the basis of the customization ID “C0101”, and displays the personal setting screen illustrated in FIG. 6B in the operation screen of the operation panel 21 of the image forming apparatus 10.

When the CPU 11 receives a user ID “U005” and a password “5555” as a result of login of user E, the CPU 11 obtains a customization ID “C0103” corresponding to the user ID “U005” and the password “5555” from the authentication information management table stored in the storage device 14. The CPU 11 then reads customization information for C0103 on the basis of the customization ID “C0103”, and displays the personal setting screen illustrated in FIG. 6C in the operation screen of the operation panel 21 of the image forming apparatus 10.

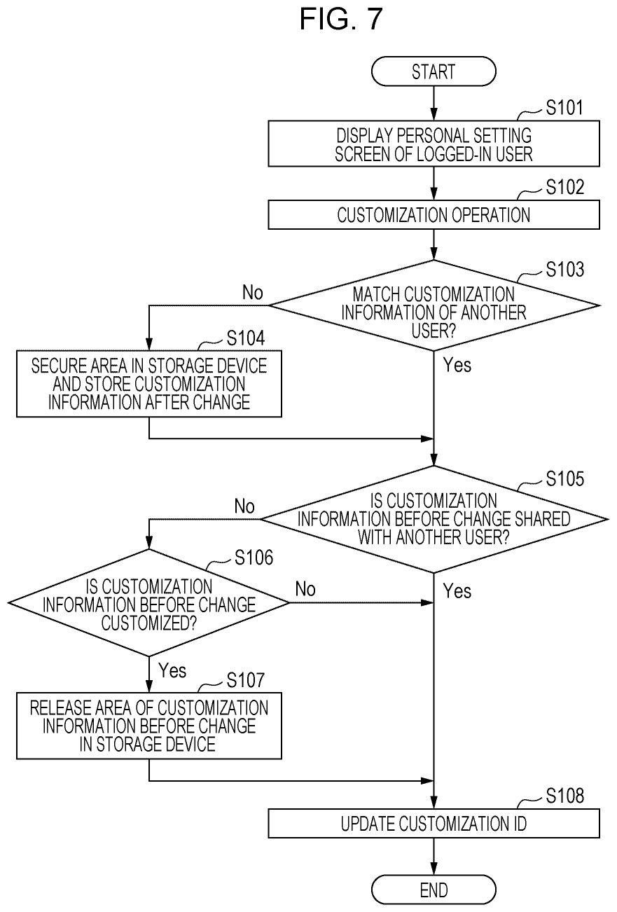

Next, the operation of the image forming apparatus 10 according to the present exemplary embodiment will be described in detail with reference to FIGS. 7 to 9B.

A case where a personal setting screen of user E is customized will be described hereinafter.

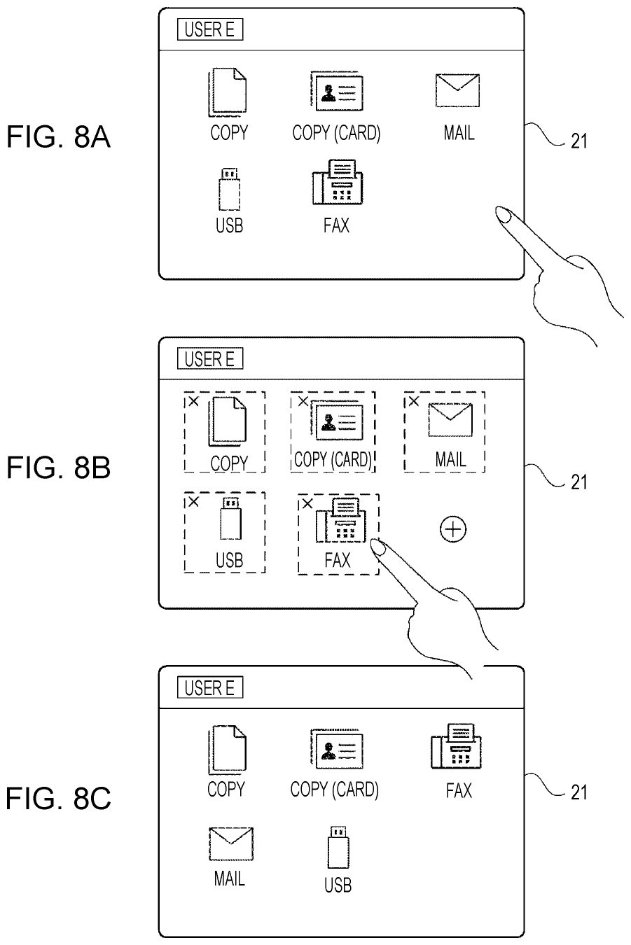

First, in step S101, the CPU 11 receives the authentication information using the authentication unit 19 as a result of the above-described login operation by the user, and displays the personal setting screen of the user in the operation screen of the operation panel 21. For example, as a result of a login operation by user E, a personal setting screen of user E illustrated in FIG. 8A is displayed in the operation screen of the operation panel 21.

In step S102, the CPU 11 receives a customization operation such as removal, addition, or movement of an icon on the operation screen.

Specifically, for example, by pressing and holding the operation screen of the operation panel 21 as illustrated in FIG. 8A, a customization operation such as removal, addition, or movement of an icon on the operation screen can be performed as illustrated in FIG. 8B. Arrangement of icons can then be customized by removing a target icon with a tap on an “×” button, adding an icon not displayed in the operation screen with a tap on a “+” button, or moving a target icon through a drag operation. In addition, settings of icons can be customized by changing a name of an icon or print settings or registering an address of the facsimile function or a mail address of the mail transmission function. By tapping the operation screen again, the customized screen (also referred to as a personal setting screen) is determined as the operation screen as illustrated in FIG. 8C.

In step S103, the CPU 11 determines whether the customization information regarding the personal setting screen after the change matches customization information regarding a personal setting screen of another user stored in the customization information management table stored in the storage device 14. If not, the process proceeds to step S104, and if so, the process proceeds to step S105.

In step S104, the CPU 11 secures a new storage area of the storage device 14, and stores the customization information regarding the personal setting screen after the change in the secured storage area. That is, if the customization information regarding the personal setting screen after the change does not match customization information regarding a personal setting screen of another user stored in the customization information management table stored in the storage device 14, the CPU 11 secures a new storage area in the storage device 14 and stores the customization information regarding the personal setting screen after the change in the secured storage area.

In step S105, the CPU 11 determines whether the customization information regarding the personal setting screen before the change is shared with another user. If not, the process proceeds to step S106, and if so, the process proceeds to step S108.

In step S106, the CPU 11 determines whether the customization information regarding the personal setting screen before the change is customization information customized from the initial settings. If so, the process proceeds to step S107, and if not, the process proceeds to step S108.

In step S107, the CPU 11 releases, in the storage device 14, an area of the customization information regarding the personal setting screen before the change. That is, if the customization information regarding the personal setting screen before the change is not shared as customization information regarding a personal setting screen of another user stored in the customization information management table stored in the storage device 14 and is not the initial settings, the CPU 11 releases, in the storage device 14, a storage area of the customization information regarding the personal setting screen before the change.

In step S108, the CPU 11 updates the customization ID of the authentication information management table of the user.

That is, if the customization information customized from the initial settings by the user who has customized the operation screen matches customization information of another user already stored in the storage device 14, the CPU 11 updates a customization ID corresponding to the customization information of the other user and stores the updated customization ID in the authentication information management table stored in the storage device 14 without securing a new storage area in the storage device 14. The amount of memory used in the storage device 14 can thus be reduced by referring to and displaying customization information of another user stored in the storage device 14 without securing a new storage area.

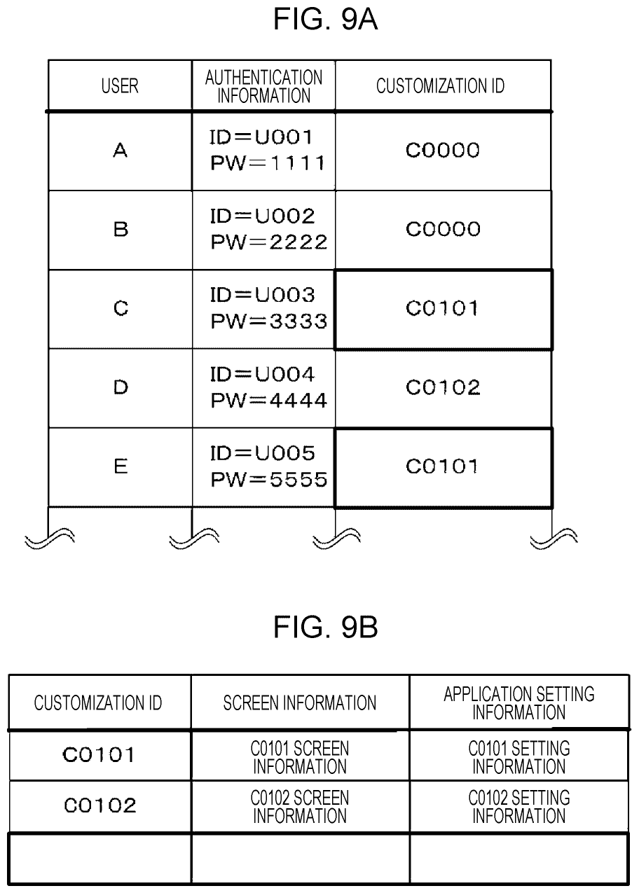

Specifically, for example, if the customization information regarding the personal setting screen of user E after the change matches the customization information regarding a personal setting screen of user C, the customization ID of user E is changed from “0103” to “0101”, which is the customization ID of user C as illustrated in FIG. 9A, and the personal setting screen of user E is displayed using the customization information regarding the personal setting screen of user C. If the customization information regarding the personal setting screen of user E before the change is not shared with another user, a storage area of “C0103”, which is the customization ID of the customization information management table, is released as illustrated in FIG. 9B. That is, the amount of memory used in the storage device 14 is reduced.

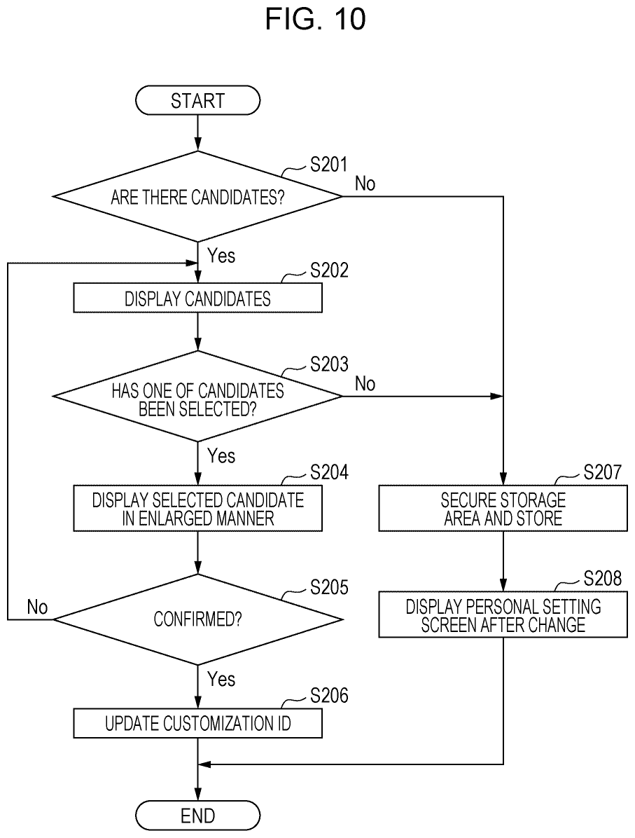

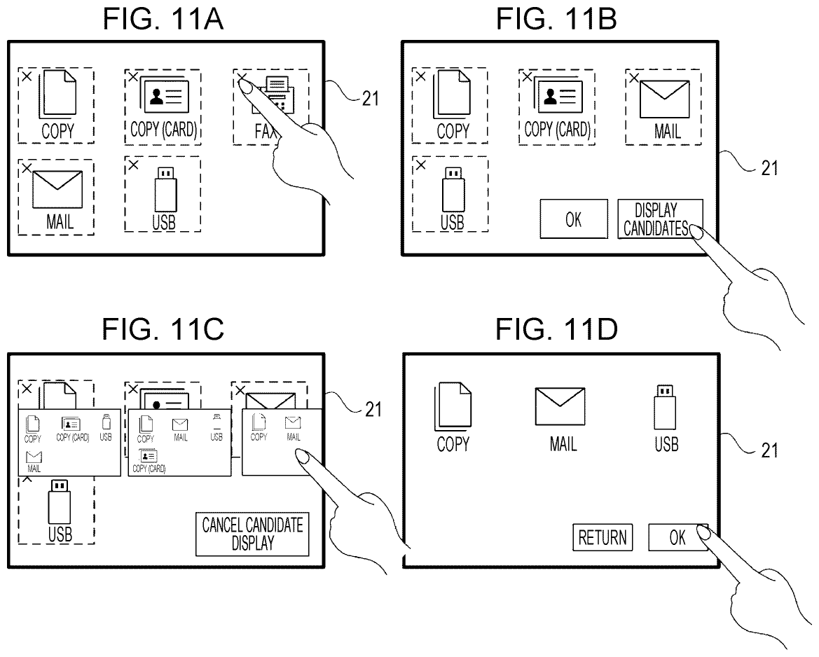

Next, another example of the above-described operation of the image forming apparatus 10 will be described with reference to FIGS. 10 to 11D.

In the following description, another example of the case where the customization information regarding the personal setting screen after the change does not match customization information of another user already stored in the storage device 14 in step S103 will be described.

In step S201, if the customization information regarding the personal setting screen after the change does not match customization information of another user already stored in the storage device 14, the CPU 11 determines whether customization information regarding person setting screens of other users that serve as candidates is stored in the customization information management table in comparison with the customization information regarding the personal setting screen after the change. If so, the process proceeds to step S202, and if not, the process proceeds to step S207.

In step S202, the CPU 11 sequentially arranges the personal setting screens of other users that are already stored in the storage device 14 and that are close to the personal setting screen after the change in the operation screen from the left and presents the personal setting screens as candidate screens. Order of display of the candidate screens is determined, for example, by evaluating a plurality of evaluation items in order of priority. The number of candidate screens to be displayed is smaller than a predetermined value.

At this time, the CPU 11 presents, as the candidate screens, personal setting screens based on customization information of the other users that are already stored in the storage device 14 and in which, for example, compared with the personal setting screen after the change, a removed icon is not included, an added icon is included, or a position of a moved icon matches.

At this time, the CPU 11 may present, as the candidate screens, personal setting screens based on the customization information of the other users that are already stored in the storage device 14 on the basis of an evaluation such as, compared with the personal setting screen after the change, the number of the same icons is large, the number of icons at the same positions is large, or the total number of icons is close.

For example, if an operation of removing an icon on the operation screen has been performed, first, personal setting screens of other users including the removed icon are excluded from candidate screens. Personal setting screens of other users that do not include the removed icon are then evaluated in order from “the number of the same icons is large”, “the number of icons at the same positions is large”, and “the total number of icons is close”, and displayed as candidate screens in order of priority.

If an operation of adding an icon to the operation screen has been performed, first, personal setting screens of other users that do not include the added icon are excluded from candidate screens. Personal setting screens of other users that include the added icon are then evaluated in order from “the number of the same icons is large”, “the number of icons at the same positions is large”, and “the total number of icons is close”, and displayed as candidate screens in order of priority.

If an operation of moving and rearranging an icon in the operation screen has been performed, first, personal setting screens of other users in which a position of the moved icon matches are evaluated in order from “the number of the same icons is large”, “the number of icons at the same positions is large”, and “the total number of icons is close”, and displayed as candidate screens in order of priority.

If an operation of customizing settings of an icon in the operation screen has been performed, personal setting screens of other users having the same settings of the customized icon are evaluated in order from “the number of the same icons is large”, “the number of icons at the same positions is large”, and “the total number of icons is close”, and displayed as candidate screens in order of priority.

Specifically, for example, if user A has removed an icon of the facsimile function, personal setting screens of other users that do not include the removed icon of the facsimile function are extracted. Thereafter, among the personal setting screens of other users that do not include the removed icon of the facsimile function, first, personal setting screens in which the number of the same icons is large are preferentially displayed, personal setting screens in which the number of icons at the same positions is large are then displayed, and personal setting screens in which the total number of icons is large are then displayed.

The order of display of the personal setting screens of other users as the candidate screens may be weighted in accordance with the priority of the evaluation items, and the sum of the evaluation items may be used as an evaluation value. The personal setting screens of other users may then be displayed as the candidate screens from the left in order of the evaluation value. If there is a plurality of screens having the same evaluation value, the screens may be arranged in order of registration.

Specifically, for example, if user C has removed the icon of the facsimile function, the personal setting screen of user C and personal setting screens of other users that do not include the removed icon of the facsimile function are compared, and “the number of the same icons×3+the number of icons at the same positions×2−(a difference between the total number of icons of the personal setting screen of user C and the total number of icons of the personal setting screen of another user)” is calculated as the evaluation value. The personal setting screens of other users are then displayed as the candidate screens from the left in order of the evaluation value.

More specifically, when the personal setting screen of the user C and a personal setting screen of the user F that does not include the removed icon of the facsimile function are compared and the number of the same icons is 4, the number of icons at the same positions is 4, and the total number of icons is the same (a difference of 0), the evaluation value of user F=4×3+4×2−0=20. The personal setting screen of user F, therefore, can be displayed as a candidate screen with higher priority (to the left) than personal setting screens of users whose evaluation values are less than 20. Personal setting screens of users whose evaluation values are more than 20 can be displayed as candidate screens with higher priority (to the left) than the personal setting screen of user F.

In step S203, the CPU 11 determines whether an operation of selecting one of the candidate screens has been performed. If so, the process proceeds to step S204, and if not, the process proceeds to step S207.

In step S204, the CPU 11 displays the selected candidate screen in an enlarged manner.

In step S205, the CPU 11 determines whether an OK button of the candidate screen displayed in an enlarged manner has been tapped. If a “return” button has been tapped without the OK button being tapped, the process returns to step S202. If the OK button is tapped, the process proceeds to step S206.

Specifically, for example, if the icon of the facsimile function is removed by tapping an “x” button in an operation screen illustrated in FIG. 11A, whether customization information regarding a personal setting screen of another user that is the same as this personal screen is stored in the customization information management table in the storage device 14. If not, a “display candidates” button illustrated in FIG. 11B is displayed in the operation screen. By selecting the “display candidates” button, candidate screens illustrated in FIG. 11C are superimposed upon the operation screen. By selecting one of the candidate screens, the selected candidate screen is displayed in an enlarged manner as illustrated in FIG. 11D, and the candidate screen displayed in an enlarged manner is determined as the personal setting screen by selecting an “OK” button.

In step S206, the CPU 11 updates the customization ID of the user to a customization ID that is information for referring to customization information regarding the selected candidate screen and stores the customization ID in the authentication information management table in the storage device 14 without securing a new storage area in the storage device 14. The amount of memory used in the storage device 14 can thus be reduced by referring to customization information of other users stored in the storage device 14 using candidate screens. In addition, by using candidate screens, customization can be performed more efficiently, which improves convenience.

In step S207, that is, if there is no candidate or if one of presented candidate screens is not selected even though there are candidates, the CPU 11 secures a new storage area in the storage device 14, and stores the customization information regarding the personal setting screen after the change in the secured storage area.

In step S208, the CPU 11 displays the personal setting screen on the basis of the customization information after the change.

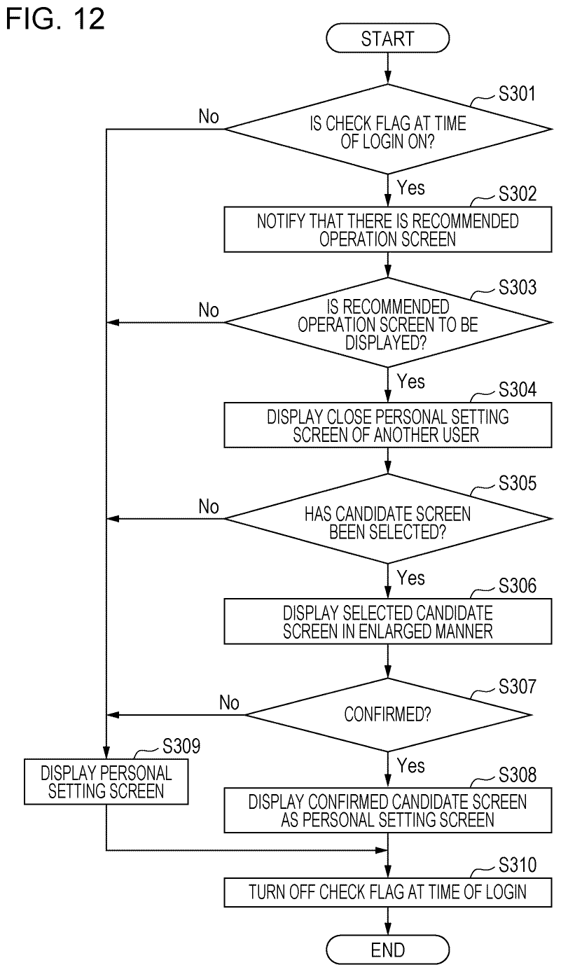

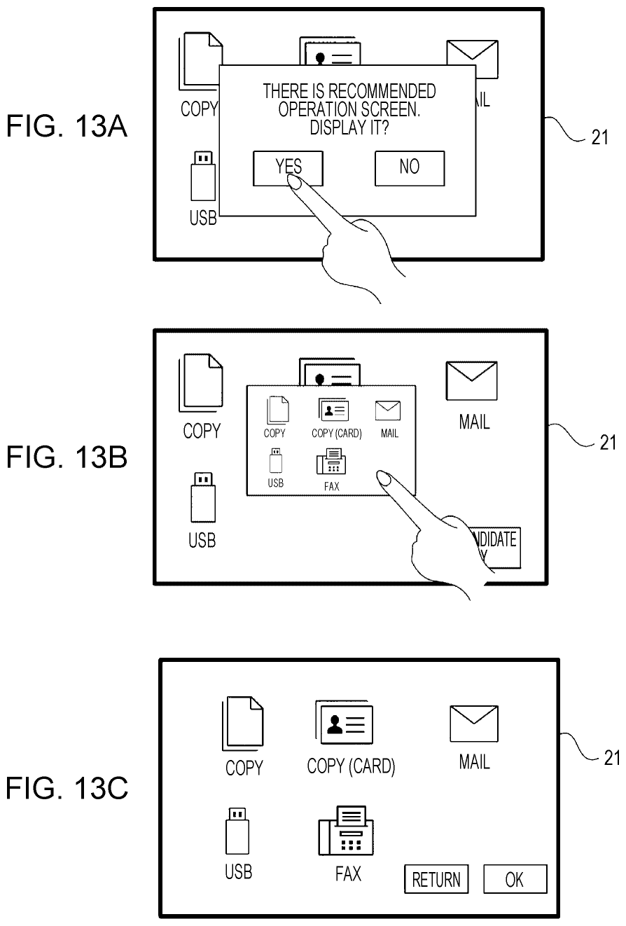

Another example of the above-described operation of the image forming apparatus 10 will be described with reference to FIGS. 12 to 13C.

In the following description, another example of the operation in a case where a new storage area is secured in the storage device 14 in step S207 described above, and the customization information regarding the personal setting screen after the change is stored in the secured storage area will be described.

At this time, the CPU 11 turns on a check flag of the personal setting screen after the change. The CPU 11 can also turn off the check flag of the personal setting screen after the change by a user operation. By turning on the check flag, the personal setting screen after the change can be presented as a candidate screen when another user whose personal setting screen has been displayed as a candidate screen logs in. By turning off the check flag, the CPU 11 can prevent the personal setting screen of the user after the change from being presented as a candidate screen when another user whose personal setting screen has been displayed as a candidate screen logs in.

Specifically, for example, if none of the candidate screens is selected and a “cancel candidate display” button in an operation screen displaying the candidate screens illustrated in FIG. 11C is selected in step S203 described above, the check flag is turned on. At this time, the personal setting screen after the change may be stored in association with a customization ID of a candidate screen that has not been selected from among the candidate screens.

In step S301, the CPU 11 determines whether a check flag of a customization ID corresponding to authentication information regarding a logged-in user is on. If the check flag is on, the process proceeds to step S302, and if the check flag is off, the process proceeds to step S309.

In step S302, the CPU 11 notifies that there is a recommended operation screen, for example, as illustrated in FIG. 13A.

In step S303, the CPU 11 determines whether to display the recommended operation screen on the operation screen. For example, whether a “yes” button has been selected on the operation screen illustrated in FIG. 13A. If the “yes” button has been selected, the process proceeds to step S304. If a “no” button has been selected, the process proceeds to step S309.

In step S304, the CPU 11 displays, as illustrated in FIG. 13B, for example, a personal setting screen of another user close to the personal setting screen of the logged-in user as a candidate screen.

In step S305, the CPU 11 determines whether the candidate screen has been selected on the operation screen. If so, the process proceeds to step S306, and if not, the process proceeds to step S309.

In step S306, the CPU 11 enlarges the selected candidate screen, for example, as illustrated in FIG. 13C.

In step S307, the CPU 11 determines whether an OK button of the enlarged candidate screen has been tapped. If so, the process proceeds to step S308. If a “return” button has been tapped without the OK button being tapped, the process proceeds to step S309.

In step S308, the CPU 11 displays the candidate screen whose OK button has been tapped as the personal setting screen of the user.

In step S309, the CPU 11 displays the personal setting screen on the basis of customization information corresponding to the customization ID of the user.

In step S310, the CPU 11 turns off the check flag at a time of the login of the user.

By displaying, as a candidate screen, a personal setting screen based on customization information stored without being selected when another user whose personal setting screen has been displayed as a candidate screen logs in, the personal setting screen of the other user can be guided to the same personal setting screen as that of the user, the amount of memory used in the storage device can be reduced, and personal setting screens of more users can be stored.

Although an example in which the present disclosure is applied to the operation panel 21 of the image forming apparatus 10 has been described in the above exemplary embodiment, the present disclosure is not limited to this. The present disclosure can be similarly applied to another information processing apparatus such as the terminal apparatus 20, which is a smartphone, a tablet terminal, a personal computer, or the like.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The “system” in the present embodiment includes both a system including a plurality of apparatuses and a system including a single apparatus.

The technique in the present disclosure can be applied to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An Information processing system including:
a memory; and
a processor configured to store, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.
(((2)))

The information processing system according to (((1))),
in which the processor is configured to secure, if the personal setting information of the user who has changed the operation screen does not match personal setting information of another user already stored in the memory, a new storage area in the memory and store the personal setting information of the user who has changed the operation screen in the secured storage area.
(((3)))

The information processing system According to (((1))),
in which the processor is configured to present, if the personal setting information of the user who has changed the operation screen does not match personal setting information of another user already stored in the memory, operation screens based on personal setting information of other users already stored in the memory and close to the personal setting information of the user who has changed the operation screen as candidate screens.
(((4)))

The information processing system according to (((3))),
in which the processor is configured to store, if one of the presented candidate screens is selected, information for referring to the personal setting information of the other user regarding the selected candidate screen in the memory as the personal setting information of the user without securing a new storage area in the memory.
(((5)))

The information processing system according to (((3))),
in which the processor is configured to secure, if none of the presented candidate screens is selected, a new storage area in the memory and store the personal setting information of the user who has changed the operation screen in the secured storage area.
(((6)))

The information processing system according to any of (((1))) to (((5))),
in which the information regarding the operation screen is information regarding arrangement of controls in the operation screen, names of the controls, or operation settings of programs activated by the controls.
(((7)))

The information processing system according to (((6))),
in which the information regarding the arrangement of the controls includes information regarding removal of a control in the operation screen, addition of a control, or movement of a control.
(((8)))

The information processing system according to (((7))),
in which the processor is configured to present, as candidate screens, operation screens based on personal setting information of other users that are already stored in the memory and in which, compared with the personal setting information of the user who has changed the operation screen, the removed control is not included, the added control is included, or a position of the moved control matches.
(((9)))

The information processing system according to (((8))),
in which the processor is configured to present, as candidate screens, operation screens based on personal setting information of other users that are already stored in the memory and in which, compared with the personal setting information of the user who has changed the operation screen, a number of same icons is large, a number of icons at same positions is large, or a total number of icons is close.
(((10)))

The information processing system according to (((5))),
in which the processor is configured to present, if personal setting information regarding another user presented as one of the candidate screens is changed by the other user, the operation screen based on the personal setting information stored in a new storage area secured in the memory without any of the candidate screens being selected as a candidate screen.
(((11)))

The information processing system according to (((5))),
in which the processor is configured to be, if personal setting information of another user presented as one of the candidate screens is changed by the other user, able to make a setting such that the operation screen based on the personal setting information stored in a new storage area secured in the memory without any of the candidate screens being selected is not displayed as a candidate screen.
(((12)))

A program causing a computer to execute a process including:
storing, if a user has changed an operation screen and personal setting information, which is information regarding the operation screen changed from an initial setting, matches personal setting information of another user already stored in the memory, information for referring to information of the user without securing a new storage area in the memory.

What is claimed is:

1. An information processing system comprising:
a memory; and
a processor configured to store, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.

2. The information processing system according to claim 1,
wherein the processor is configured to secure, if the personal setting information of the user who has changed the operation screen does not match personal setting information of another user already stored in the memory, a new storage area in the memory and store the personal setting information of the user who has changed the operation screen in the secured storage area.

3. The information processing system according to claim 1,
wherein the processor is configured to present, if the personal setting information of the user who has changed the operation screen does not match personal setting information of another user already stored in the memory, operation screens based on personal setting information of other users already stored in the memory and close to the personal setting information of the user who has changed the operation screen as candidate screens.

4. The information processing system according to claim 3,
wherein the processor is configured to store, if one of the presented candidate screens is selected, information for referring to the personal setting information of the other user regarding the selected candidate screen in the memory as the personal setting information of the user without securing a new storage area in the memory.

5. The information processing system according to claim 3,
wherein the processor is configured to secure, if none of the presented candidate screens is selected, a new storage area in the memory and store the personal setting information of the user who has changed the operation screen in the secured storage area.

6. The information processing system according to claim 1,
wherein the information regarding the operation screen is information regarding arrangement of controls in the operation screen, names of the controls, or operation settings of programs activated by the controls.

7. The information processing system according to claim 6,
wherein the information regarding the arrangement of the controls includes information regarding removal of a control in the operation screen, addition of a control, or movement of a control.

8. The information processing system according to claim 7,
wherein the processor is configured to present, as candidate screens, operation screens based on personal setting information of other users that are already stored in the memory and in which, compared with the personal setting information of the user who has changed the operation screen, the removed control is not included, the added control is included, or a position of the moved control matches.

9. The information processing system according to claim 8,
wherein the processor is configured to present, as candidate screens, operation screens based on personal setting information of other users that are already stored in the memory and in which, compared with the personal setting information of the user who has changed the operation screen, a number of same icons is large, a number of icons at same positions is large, or a total number of icons is close.

10. The information processing system according to claim 5,
wherein the processor is configured to present, if personal setting information regarding another user presented as one of the candidate screens is changed by the other user, the operation screen based on the personal setting information stored in a new storage area secured in the memory without any of the candidate screens being selected as a candidate screen.

11. The information processing system according to claim 5,
wherein the processor is configured to be, if personal setting information of another user presented as one of the candidate screens is changed by the other user, able to make a setting such that the operation screen based on the personal setting information stored in a new storage area secured in the memory without any of the candidate screens being selected is not displayed as a candidate screen.

12. A non-transitory computer readable medium storing a program causing a computer to execute a process comprising:
storing, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.

13. A method comprising:
storing, if a user has changed an operation screen and personal setting information, which is information regarding the operation screen changed from an initial setting, matches personal setting information of another user already stored in the memory, information for referring to the personal setting information of the other user in the memory as the personal setting information of the user without securing a new storage area in the memory.
